(19) United States
(12) Patent Application Publication
(10) Pub. No.: US 2003/0174802 A1
(43) Pub. Date: Sep. 18, 2003

(54) MOULDED RADIATION SHIELD

(76) Inventor: JOHN THOMAS HARE, NORTHUMBERLAND (GB)

Correspondence Address: WILSONART INTERNATIONAL, INC., C/O WELSH & FLAXMAN, LLC, 2341 JEFFERSON DAVIS HIGHWAY, SUITE 112, ARLINGTON, VA, 22202, US

(21) Appl. No.: 08/793,416

(22) PCT Filed: Aug. 25, 1995
(86) PCT No.: PCT/GB95/02013

(30) Foreign Application Priority Data
Aug. 25, 1994 (GB) 9417175.8

(51) Int. Cl. G21C 9/00

(52) U.S. Cl. 376/287

(57) ABSTRACT

A moulded shield for a source of gamma-rays said shield defining a cavity to receive said source and comprising a core layer of cured liquid silicone resin loaded with particulate gamma radiation-shielding material adapted to surround a radiation source located in said cavity, said core layer being located between two outer layers of solid polymeric material. Also a method of forming a tubular shield.

The invention relates to radiation shielding material primarily intended for shielding sources of gamma rays, such as are found in association with nuclear-powered steam raising installations and the like.

In such installations, ancillary equipment and apparatus such as valves, pumps and pipes of the steam generating circuit, located in areas to which human access may be required, e.g. for routine maintenance, overall and repairs, can become contaminated with radiation and it is therefore desirable to protect the operatives who have to enter and work in it. There are also many other working environments in which such protection is desirable, e.g. in hospitals and in experimental laboratories and operational situations employing machinery generating gamma rays, e.g. as in non-destructive testing of materials, and in situations where apparatus has to be removed from a radioactive area e.g. for maintenance or repair.

One approach to the protection of operatives is the provision of protective clothing such as gloves, overalls, etc, and a wide range of materials has been proposed for the manufacture of such clothing. In general, they comprise plastics sheets filled with particles of radiation protective material such as lead, the sheets optionally being interposed between two outer layers such as of fabric or plastics reinforced fabric. Such materials are described, for example in GB-A-670325, 680715, 703153, 851479, 954594, 1122766 and 2118410, EP-A-0117884 and U.S. Pat. No. 5,001,354. GB-A-954594, for example, describes a clothing material for use in the manufacture of gloves, helmets, aprons, leggings and the like, and comprising a layer made of silicone rubber, lead powder and flock, interposed between and bonded to two layers of fabric. However, the clothing made from these materials must, if it is to provide adequate protection against high energy level gamma rays, be heavy and relatively inflexible, making it restrictive and tiring for the operator to work in for any length of time.

Another approach has been to attempt to shield the radiation source itself. A conventional way of doing this is to employ lead sheet. One method of using this is to hang it from overhead fixings or to drape it over the parts to be shielded. Attempts have also been made to form covers of various shapes from lead sheet. However, its use is restricted because of its weight, its lack of flexibility and its unsuitability where direct contact with metal parts, which are usually made of stainless steel, is required.

Alternatives to the lead sheets, which comprise sheets of lead foil or of lead powder-filled plastics between outer layers which may be of flexible plastics or plastics-impregnated cloth, are suggested in GB-A-851479, GB-A-887956, the aforementioned GB-A-954594 and U.S. Pat. No. 3,622,432. However, protection by use of sheeting is cumbersome and, tends to take up too much space, especially in restricted environments, and can take a significant time to erect. Further there may be no convenient fixings or other means of supporting the sheets. Moreover, the shielding of some fittings, such as T-pieces, is not readily achieved using sheet material, even if it is shaped into a housing.

The present invention takes an entirely different approach which involves the manufacture of pre-formed moulded parts tailored to house or enclose a particular radiation source. The parts have the advantage of being compact and fitted rapidly.

DE-A-2822494 observes that silicone rubbers and resins give effective shielding against γ-radiation and that flexible radiation-protective materials based on silicones can be moulded to any desired shape and thickness. FR-A-2027514, on the other hand, teaches that silicone rubbers are not suitable for γ-ray shields because they are damaged by the γ-rays.

According to the present invention, there is provided a moulded shield for a source of γ-rays said shield defining a cavity to receive said source and comprising a core layer of cured liquid silicone resin loaded with particulate γ radiation-shielding material and adapted to surround a radiation source located in said cavity, said core layer being located between two outer layers of solid polymeric material.

The invention also provides a shielded γ-ray radiation source wherein the shield is as defined above and the source is located in said cavity.

The shield may comprise a single part or a plurality of co-operating parts which together define the cavity. Where the shield is formed of a plurality of parts which together define the cavity, it will be understood that each part will comprise a core layer between two outer layers of said solid polymeric material.

In one embodiment, the core layer is encapsulated in said solid polymeric material.

Silicone rubber is used for the core layer because it is readily mouldable, has excellent physical properties and, unlike many elastomeric materials and resins, is compatible with and unaffected by the usual radiation-shielding materials such as lead powder. Moreover, it is able to retain its elastomeric properties over the wide range of temperatures that may be met in practice, from the low climatic temperatures that may be encountered in some regions of the world to the elevated temperatures that may be encountered during the initial stages after shut down of a nuclear reactor or during the period of setting up a reactor after shut down.

A major use of the shields of the invention is for fitting over ancillary equipment associated with nuclear power installations, such as in the steam generating circuitry of nuclear power steam raising installations and the like, and to which access is required e.g. for routine maintenance or repairs. In general, such equipment is of metal, e.g. as in pipes, pipe bends, pipe T-junctions, and the like, where radiation hot spots tend to develop. The presence of the outer layers of solid polymeric material in the shield of the invention ensures that the particulate radiation shielding material, such as lead powder, which is incorporated in the core layer is separated from such metal parts, thereby obviating the risk of electrolyte attack, which is particularly likely to occur in damp, humid or wet environments. The outer layers also enable the core layer to have a higher loading of the particulate material than would otherwise by possible while still retaining cohesiveness, tear strength and the ability of the moulded shield to support its own weight, thereby enabling a desired level of attenuation to be achieved at a reduced level of wall thickness in the shield.

By careful design of the shape of the shield, or of the individual parts forming the shield where it comprises a plurality of co-operating parts, shine, i.e. the leakage of radiation, can be substantially eliminated or at least significantly reduced as compared with the conventional use of shielding devised from an ad hoc assemblage of sheets or tiles.

The shields of the invention may be provided in a wide variety of shapes and forms, the more common examples of which are tubular, e.g. to cover pipes; domes, e.g. for covering valves and valve housings, thermocouple housings and like pipe fittings; and boxes. By employing a plurality of co-operating parts, more complex shapes and forms can readily be produced, e.g. T-shaped boxes such as for covering pipe T-junctions.

While the shields of the invention are useful for the attenuation of γ-rays in the range 0.005 to 1.4 Å wavelength generally, they are particularly suitable for attenuation of high energy level γ radiation such as from cobalt 60, iridium 192 and caesium 137 wherein the energy levels are at least 100 KeV and can be as high as 500 KeV or even 1 MeV and higher.

The invention will now be described in more detail with reference to preferred embodiments and with the aid of the accompanying drawings in which:

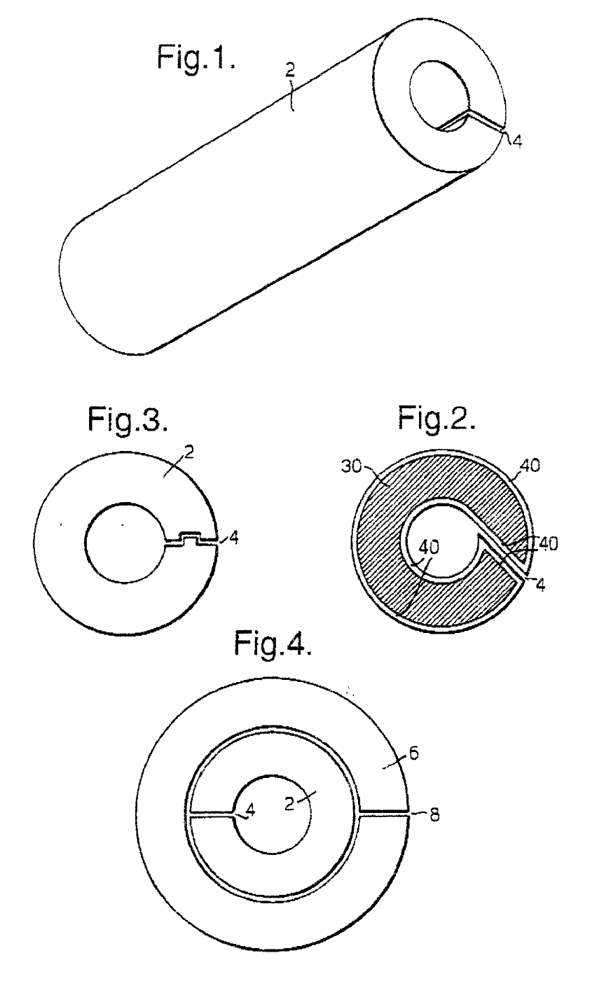

FIG. 1 is a diagrammatic representation of a shield in the form of a split tube for fitting over a pipe;

FIG. 2 illustrates an alternative embodiment to the tube of FIG. 1 and is in cross-section to show the internal structure of the tube;

FIG. 3 is an end view of an alternative to the tube of FIG. 2;

FIG. 4 is an end view of a shield for a pipe provided by two concentric split tubes of the kind illustrated in FIG. 1;

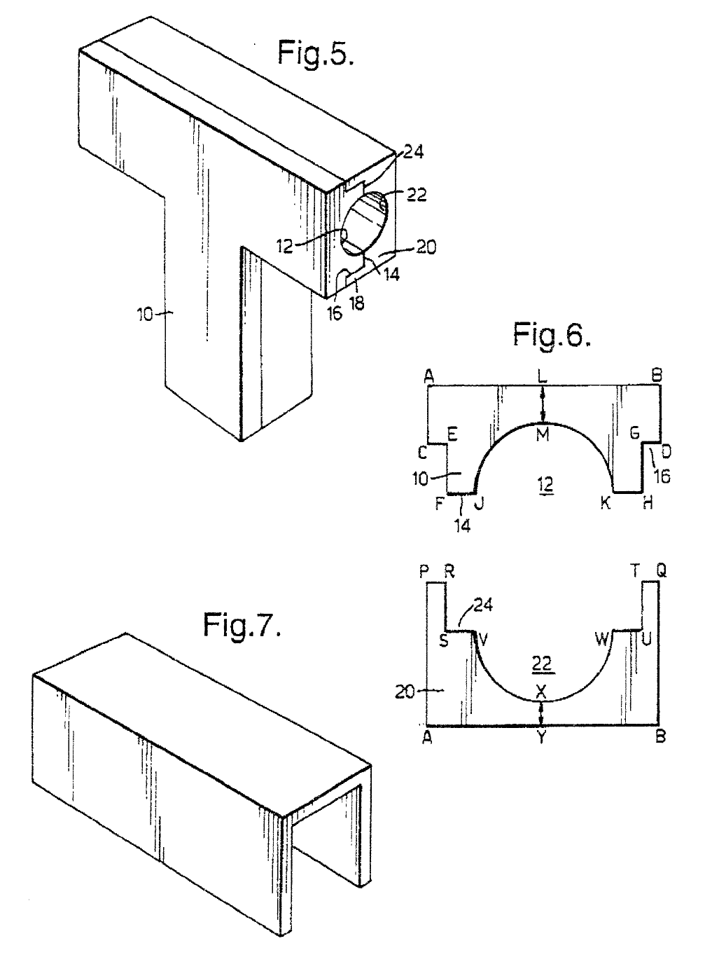

FIG. 5 is a perspective view of a two-part moulded shield intended to fit over a pipe T-piece;

FIG. 6 is an exploded view of an enlarged cross-section through one arm of the moulding of FIG. 5 but with the internal structure omitted for ease of reference; and

FIG. 7 is a perspective view of another moulding according to the invention.

Depending on the nature of the radiation source and the shape of the piece of equipment to be shielded, the shield may comprise a single moulding or a plurality of separate cooperating parts which together define the cavity and enclose the radiation source.

For example, for protecting pipes, the shield may be in the form of a tube 2 (FIG. 1) with a longitudinal slit 4 and which because it is made of resilient material, can be opened along the slit so that it can be pushed over a length of pipe and then closed over the pipe, e.g. by the use of quick-locating plastics straps (not shown) of the well known kind such as used as ties in horticulture. In one preferred embodiment, the tube is flexible so that it may accommodate curves and bends in pipes.

To reduce or eliminate shine, the slit is preferably so formed that when the tube is closed over the pipe, the protection provided by the tube is unbroken. For example, the slit 4 may extend from the inner face to the outer face of the tube at an angle to the radius (FIG. 2). An alternative, wherein the slit is in the form of a double-crank, or dog-leg, is shown in FIG. 3. Alternatively, as illustrated in FIG. 4, a second split tube 6 may enclose the first, with the slit 8 located at a different circumferential position to the slit 4 of the first tube 2. Thus, in this embodiment, the shield comprises the pair of split tubes.

As stated above, the shield may comprise a plurality of separate moulded parts which together define a cavity to enclose the radiation source. Thus, for example, it will also be apparent that if desired, the shield for a pipe length may be formed from a two-part moulding wherein each part has a longitudinally extending cavity which is generally semi-circular in cross-section, the parts fitting together to enclose the pipe.

By way of further example, a two-part moulding suitable for enclosing a pipe T-piece is illustrated in FIGS. 5 and 6. The moulding comprises two parts designed to mate along the plane of the axes of the T-joint and each part 10, 20, is thus, in plan, in the form of a T and contains a pipe-receiving cavity 12, 22 which is generally semi-circular in cross-section. The parts are so designed as to overlap when placed together in order to reduce or eliminate shine. Thus, in the embodiment illustrated in FIGS. 5 and 6, the face 14 of the part 10 which is intended to mate with the face 24 of the part 20 to form the cavity of the pipe T piece is provided along each of its longitudinal edges with a cut-away step portion 16 which receives a lug 18 formed along the corresponding longitudinal edge of the mating face of the part 20.

Other means of eliminating shine will be apparent to those skilled in the art. For example, clips 30 (FIG. 7) may be provided for fitting over the two parts which enclose the T-piece, to cover the joints between the parts, and which are themselves mouldings according to the invention.

As illustrated in FIG. 2, which is a cross-section through a tubular shield according to the invention the shield comprises a core layer which is represented in the drawing by the shaded area 30, of cured liquid silicone resin loaded with particulate radiation shielding material adapted to surround the radiation source located in the cavity. The core layer is located between two layers 40 of unfilled and solid polymeric material. In the embodiment illustrated, the core layer is actually encapsulated within the solid polymeric material which, as shown, completely surrounds the core 30. Where the shield is formed of several parts, the core layer of each part is so formed that when the parts are assembled to form the shield, the radiation source located in the cavity defined by the shield is substantially surrounded by core layer. It will be understood that when the core layer of each part is encapsulated in solid polymeric material, there will be small areas around the cavity unprotected by the core layer but this can be rectified by providing a further part and locating it so that its core layer covers the area in question. Alternatively, and preferably, the parts are constructed and arranged to fit together with overlap.

The polymeric material for the outer layer should be capable of withstanding the extremes of temperature which the shield is likely to meet in practice without unacceptable loss of strength or becoming embrittled. Where the shield is required to be flexible, it is also necessary for the material to be elastomeric, However, it is preferred that it is substantially free of halide and sulphide since such materials can attack the metals from which the components to be located in the cavity of the shield are frequently made, especially in wet or humid conditions. Where the shields are likely to be used in enclosed environments, it is also preferred that they are also substantially free of nitrogen and phosphorus because of the toxic fumes that may be generated in the event of fire. Thus, in general it is preferred to avoid the use of such materials as polyamides, polyimides, polyurethanes, polysulphides, polysulphones, vinyl chloride or vinylidene chloride polymers and chloroprenes.

Expended materials of foams should also be avoided because they undesirably increase the bulk of the product.

Much preferred for the outer layer are resins derived by curing liquid resin systems. Silicone, especially silicone elastomer of the kind used in the manufacture of moulds, is particularly preferred because of its compatibility with the material of the core layer, because it avoids the need for adhesives to bond the core layer to the outer layers, and because its generally non-wetting qualities render it easy to clean if the surface becomes accidentally contaminated. Furthermore, this material not only has acceptably low levels of chloride, sulphide and nitrogen but also exhibits a desirable combination of physical properties, especially tear strength, flexural strength and Shore hardness throughout a wide temperature range e.g. from sub-zero to above the boiling point of water. It is also readily moldable into complex shapes using inexpensive moulds and uncomplicated procedures, and without the need for pressure or more than mildly elevated temperatures. In some cases curing can be achieved at room temperature although it may be desirable to apply heat to accelerate the cure.

For less critical uses, other casting materials which may be employed include, for example, curable liquid polyesters, epoxies and phenolics.

Of course, it is not essential that the outer layers are formed of the same material; the layer forming the inner surface of the shield may be of a different material to that forming the outer surface. However, generally it is convenient to use the same material for both.

While any suitable particulate radiation-screening material may be used for the core layer provided the particles can be incorporated in the chosen silicone and do not adversely affect it, e.g. are inert to it, the preferred material is lead. In general, it will be preferred to include as high a proportion of the radiation screening material in the core as possible consistent with obtaining a coherent product. In general, however, the limiting factor is the volume of particles that can be mixed into the polymer. For lead particles and silicone elastomer, a preferred concentration of the particles is in the range 50 to 95% by weight, more preferably 75 to 95% based on total weight of lead particles and silicone. Below 50%, the radiation protection for a given thickness of the core layer of the moulding is poor, so that substantial thickness are required to achieve a desired level of attenuation, and above 95% there is difficulty in incorporating the particles into the silicone. Other radiation-screening materials may lead to different ranges of optimum concentration but these can readily be determined by simple experiment.

It will be understood that the radiation-shielding efficiency of the shield will depend not only on the concentration of radiation-shielding particles in the loaded polymer layer but also its thickness. It is therefore desirable to make the core as thick as possible relative to the total thickness of the moulding, and to minimise the thickness of the outer layers commensurate with providing the desired properties in the laminate. In general, we have found that thicknesses as small as 1 to 3 mm more generally 1 to 2 mm are adequate for these outer layers and even thinner layers, e.g. down to 0.5 mm, may be satisfactory in some cases. Of course, thicker layers may also be used but little additional advantage is likely to be gained thereby.

The overall thickness of the shield is controlled by the desired level of radiation protection on the one hand and weight or volume, or both, on the other. Preferred thicknesses of the core layer are in the range 5 to 50 mm, more preferably 5 to 20 mm, and still more preferably 8 to 16 mm.

In general, the thicker the core layer, the greater the thickness needed in the outer layers to provide the necessary support; however even at thicknesses of 50 mm for the core layer, a 1 mm thickness for the outer layer is generally adequate.

The moulded shields of the invention may be rigid or flexible and the choice will depend to some extent on the intended use. Thus, for example, it may be preferred for tubes intended to cover pipes to be flexible so as to accommodate curves and bends. However, other mouldings, e.g. to cover pipeline T pieces, may desirably be substantially rigid. The materials for the outer layers should be chosen with the flexibility or rigidity desired for the moulding in mind. Alternatively, an otherwise flexible moulding such as would be obtained from the use of elastomer in both the core and the outer layers, may be rigidified by incorporating a rigid form, e.g. metal plate, in the moulding.

The mouldings of the invention, or each part thereof where the moulding comprises a plurality of parts, may be produced by coating the outer walls of a mould with the polymeric material intended to form the outer layers, thereafter depositing the core material and then applying a further layer of the polymeric material. With the preferred choice of silicone elastomer for the outer layers, for example, the walls of the mould are first coated with curable silicone liquid. For non-horizontal surfaces, a thixotropic liquid may be employed. The coating is then caused or allowed to partially cure until it is no longer fluid but is noticeably tacky. The core composition is then located within the coated walls of the mould e.g. by forming a pourable composition of the radiation-screening particles and the silicone, and pouring the composition into the mould until the desired thickness is obtained. This core material is then caused or allowed to partially set so that it is no longer fluid. Thereafter a layer of the curable silicone liquid is applied over the core material and either levelled to the top of the mould or alternatively a lid is applied to the mould and any excess of the liquid is removed. The whole is then caused or allowed to fully cure, e.g. by application of heat.

In a preferred alternative which is suitable for the manufacture of a tubular shield, a coating of a curable liquid resin which is to form the inside, or first, layer of the shield, is applied to the surface of a mandrel while rotating the mandrel about a horizontal axis, until the desired thickness of coating has been achieved. The coating is then cured to a self-supporting but tacky state and the mandrel with the cured coating is then placed in a vertical cylindrical mould (suitably a split mould) the inner diameter of which is larger than the diameter of the coated mandrel to the extent required to permit the formation of a core layer of the desired thickness. The axis of the coated mandrel is arranged to be coaxial with that of the cylindrical mould. A pre-formed pourable mixture of curable liquid silicone resin and particulate radiation shielding material is then poured into the mould and cured to a self-supporting but tacky state. The mandrel with the inside layer and core layer is then removed from the cylindrical mould by parting the halves of a split mould and the outside layer is formed by applying a coating of curable liquid resin to the exposed surface of the core layer while again rotating the mandrel about a horizontal axis and until the desired thickness of outside layer has been obtained. This outside layer is then cured and the curing of the other layers is completed as necessary and the whole is removed from the mandrel. If the core layer is to be totally encapsulated, the ends of the tube are then coated with a layer of curable liquid resin, suitably the same as that used for the outside layer, and cured.

For optimum attenuation, it is preferred to thoroughly degas the liquid mixture of curable silicone resin and particulate radiation shielding material that it is to be used to form the core layer.

It may also be desirable to vibrate the mould during the charging of the mixture to form the core layer, to ensure that it is fully packed down.

If desired, other layers may be included in the moulding, e.g. between the core layer and one or both of outer layers and/or over one or more surfaces of the moulding, to modify its physical and/or surface properties.

Fillers and/or other additives other than the radiation-screening particles may be included in the core layer, if desired, and the outer layers may also include fillers or other additives, e.g. pigments. It may even be acceptable to include small quantities of radiation-shielding particles in an outer layer; however this is not advisable where the layer is intended to come into contact with the equipment it is shielding where that equipment is metallic, especially stainless steel.

Reinforcement, e.g. in the form of fibrous material, e.g. carbon or glass fibre, may be included in the moulding e.g. as chopped fibres, rovings or woven or unwoven webs.

A particular and very important advantage of the invention is that as the shields may be tailor made and manufactured to fit over, house or enclose particular shapes of varying sizes and degrees of complexity, the shielding can be designed specifically for a particular apparatus in a particular location and the subsequent application of the shielding to that apparatus can be achieved much more speedily than by the conventional method of draping and hanging sheets or erecting or fabricating housings on site from simple shapes such as sheets and tiles.

Examples or specific γ-radiation sources to which the shields of the invention may advantageously be applied are:

(1) parts of the pipework and fittings of steam generating circuits of nuclear-powered steam raising installations where radiation hot spots have developed. These tend to occur, for example, on bends and pipe T-joints, in the areas of valves and thermocouples, and generally at low points in the pipework;

(2) components which have become radioactive as a result of being located in a contaminated area, and which have to be removed for maintenance or repair, e.g. parts of remote-controlled handling devices;

(3) parts of gamma radiography devices e.g. non-destructive testing devices which use γ-radiography sources; e.g. parts of source projector systems such as wind-out or guide tubes and collimators.

Advantages of the shield of the invention are

the ability to manufacture it in complex shapes using simple moulding techniques without high pressure or temperatures;

the ability of the shield to be tailor made to fit over a specific piece of apparatus with substantially complete elimination of shine;

its compactness relative to the degree of shielding that can be achieved;

lack of toxicity;

its ease and speed of application thereby reducing the risk of exposure of operatives to radioactivity;

its ease of decontamination, e.g. simply by washing;

ability to withstand a wide range of temperatures e.g. from −55° C. to +150° C. or even intermittently up to +200° C. without unacceptable loss of physical properties or integrity.

While the invention has been described with particular reference to γ-rays, it is also very effective for other forms of radiation, specifically X-rays and β-particles.

The invention is now illustrated by the following Example in which all parts are by weight.

### EXAMPLE

100 parts of the base component of the silicone elastomer system marketed by Dow Corning as Silastic B, 1.09 parts of yellow pigment (WS 15414A from West and Senior Ltd. of Manchester, England), 10 parts of curing agent for the base and 0.14 part of amorphous silica as a thixotropic agent were mixed together, the resultant mixture was used to coat the walls of a mould designed to produce the moulding 10 of FIGS. 5 and 6, with a 1-2 mm coating of the material, and the mould was heated to partially cure this coating. The mould was dimensioned to produce a moulding 10 having the cross-section as shown in FIG. 6 wherein the dimension AB is 75 mm, the dimensions AC, BD, EF and GH are each 15 mm, and the dimensions CE and DG are 5 mm. JK is 40 mm and thus LM is 10 mm. The mould was constructed and oriented so that the face AB of the resultant moulding was at the top.

The composition for the core was formed by mixing together 100 parts of the same silicone base, 10 parts of curing agent and 885.5 parts of 80-200 mesh lead particles and this composition was degassed and then poured into the coated mould to fill the mould to within about 1-2 mm of the top while vibrating the mould. The mould was then heated again to partially cure this layer.

Finally, more of the first composition was poured over the partially cured core layer, sufficient being used to complete the filling of the mould and provide a layer about 1-2 mm thick, any excess being removed by doctor knife. The mould was then heated to cure the top layer and complete the curing of the first applied material and the core layer. The resultant moulding was then removed from the mould.

In similar fashion, a moulding 20 was formed having the dimensions (referring again to FIG. 6) of AB=75 mm; AP=BQ=45 mm; RS=RU=15 mm; PR=TQ=5 mm; VW=40 mm and thus XY is 10 mm. The mould was oriented so that the face AB of the moulding was at the top.

To assess the attenuation of the moulding, an approximately 8-9 mm thick tile of material was formed having a 5 mm core of the same material as the core of the moulding between two outer layers, each 1-2 mm thick, of the same material as the outer layers of the moulding. The attenuation of the tile was measured using an iridium 192 isotope and found to be approximately 50%. By way of example, typical half value thicknesses of conventionally used materials are lead 5.5 mm, iron 13 mm, concrete 43 mm. However the weight of the tile is only about two thirds that of the lead tile. Using an RO2 radiation dose meter with a 37 GBq Cs 137 source, at a dose rate of 370 micro Sv/hr, the attenuated dose was found to be 28.3% (transmitted dose about 72%).

The attenuated dose of a collimated Co 60 source of mean energy 1.25 MeV was measured at 21% at dose rates of 500 μGyh⁻¹ and 50 μGyh⁻¹ (79% transmitted dose). At about 25 mm tile thickness, the attenuation is increased to over 50%. By way of comparison, the typical half life thickness of conventional materials are lead 12.5 mm, iron 20 mm, concrete 61 mm.

A sample of the outer skin of the moulding was analysed for fluorine, chlorine and sulphur and found to contain 67.7, 24.05 and 73.3 mg/kg, respectively. The nitrogen content of the moulding was negligible.

1. A moulded shield for a source of γ-rays said shield defining a cavity to receive said source and comprising a core layer of cured liquid silicone resin loaded with particulate γ radiation-shielding material adapted to surround a radiation source located in said cavity, said core layer being located between two outer layers of solid polymeric material.

2. A shield as claimed in any one of claims 1 to 3 wherein the particulate radiation shielding material comprises lead particles.

3. A shield as claimed in claim 1 or claim 2 in which the core is encapsulated in said solid polymeric material.

4. A shield as claimed in any one of claims 1 to 3 wherein the solid polymeric material comprises cured liquid resin.

5. A shield as claimed in claim 4 wherein the solid polymeric material comprises silicone.

6. A shield as claimed in any one of claims 1 to 5 wherein the outer layers are each 0.5 to 3 mm thick.

7. A shield as claimed in any one of claims 1 to 6 wherein the core layer is 5 to 50 mm thick.

8. A shield as claimed in any one of claims 1 to 7 in the form of a tube with a longitudinal slit, for fitting over a pipe.

9. A shield as claimed in claim 8 wherein the slit is so formed as to prevent shine.

10. A shield as claimed in any one of claims 1 to 7, comprising a plurality of separate cooperating parts which together define the cavity.

11. A shield as claimed in claim 10 comprising a pair of cooperating parts which fit together to provide a cavity for a pipeline T-junction.

12. A shield as claimed in claim 10 or claim 11 wherein the parts overlap when fitted together to enclose the cavity, to prevent shine.

13. A shield as claimed in any one of claims 1 to 7 in the form of a dome.

14. A shied as claimed in any one of clams 1 to 7 in the form of a box.

15. A shielded γ-ray source wherein the shield is as defined in any one of claims 1 to 14 and the source is located in said cavity.

16. A shielded source as claimed in claim 15 wherein the source is a hot spot in the steam generating circuit of a nuclear-powered steam raising installation.

17. A shielded source as claimed in claim 15 wherein the source is a radioactive component retrieved from an area which is contaminated with radiation.

18. A shielded source as claimed in claim 15 wherein the source is a part of a gamma radiography device.

19. A method of forming a tubular γ-ray shield as claimed in claim 1, said method comprising the steps of
applying a coating of curable liquid resin to the surface of a mandrel while rotating the mandrel about a horizontal axis and until the desired thickness is obtained and curing it to a self-supporting but tacky state to form an inside layer of the shield;
mounting the coated mandrel vertically in a cylindrical mould of larger diameter, with the axis coaxial of the mandrel with that of the mould;
pouring a curable mixture of silicone resin and particulate γ-ray radiation material into the annular gap between the coated mandrel and the cylindrical mould surface and curing the mixture to a self-supporting but tacky state to form the core layer of the shield;
removing the mandrel coated with the inside layer and core layer from the cylindrical mould, applying a coating of curable liquid resin to the exposed surface of the core layer while rotating the mandrel about a horizontal axis;
completing the cure of the layers, and
removing the cured product from the mandrel.
